(19) United States
(12) Patent Application Publication
(10) Pub. No.: US 2003/0093182 A1
(43) Pub. Date: May 15, 2003

(54) Information transmission system, information transmission method, robot, information recording medium, online sales system, online sales method and sales server

(76) Inventor: Taku Yokoyama, Kanagawa (JP)

Correspondence Address: William S Frommer, Frommer Lawrence & Haug, 745 Fifth Avenue, New York, NY, 10151, US

(21) Appl. No.: 09/914,280

(22) PCT Filed: Dec. 28, 2000
(86) PCT No.: PCT/JP00/09434

(30) Foreign Application Priority Data
Dec. 28, 1999 (JP) 11/375351

(51) Int. Cl. G06F 19/00

(52) U.S. Cl. 700/245; 700/248

(57) ABSTRACT

In a mating system, a robot device for carrying out succession of inheritance information comprises inheritance information memory section (2) in which inheritance information of the robot (1) is stored; inheritance information delivery section (3) for outputting inheritance information stored in the inheritance information memory section (2) to the outside; and inheritance information producing section (4) for renewing inheritance information stored in the inheritance information memory section (2) by self-controlling action.

### TECHNICAL FIELD

The present invention relates to an information transmission system for transmitting information, an information transmission method, a robot for voluntarily deciding action, an information recording medium, an on-line sales system, an on-line sales method, and a sales server.

### BACKGROUND ART

A self-controlling type robot for voluntarily deciding action according to instructions from a user and the surrounding environment has been proposed and developed. For example, the robot of this kind has a shape which resembles closely to a quadruped having a multi-articular like a dog and a cat, and decides own action by an autonomously operating action pattern. More concretely, when the robot receives a voice command “Lie down” from a user, the robot takes a posture “Lie down” or acts like “Hand!” according to the action that the user lays his (her) hand before own mouth.

Further, some self-controlling type robot has a growth function, which robot takes action according to the growth stage by the growth function.

Incidentally, some self-supporting type has a function of expressing character and a learning function. The robot takes action according to “Testy” character or “Gentle” character by the function of expressing character. Further, information obtained in the past can be reflected to action by the learning function. For example, the robot which acquired “Kick a ball” action by the learning function takes action of kicking a ball when the robot finds a ball.

However, in the conventional self-controlling type robot, skill or character acquired during a course of the growth and the learning is concluded to be peculiar to the robot. Namely, it has been impossible that the acquired skill and character, i.e., inheritance information and succession information are succeeded by other robots and spread.

Further, recently, transactions of the goods or articles on the internet have been done actively, effectivity of which is recognized. It is considered that inheritance information of the self-controlling type robot is also transacted on the internet to thereby increase the amusing properties.

### DISCLOSURE OF THE INVENTION

The present invention has been accomplished in view of the above-mentioned circumstances. It is an object of the invention to provide an information transmission system making robots succeed inheritance information, an information transmission method, a robot, an information recording medium, an on-line sales system for selling inheritance information of robots, an on-line sales method, and a sales server.

An information transmission system according to the present invention for achieving the aforementioned object comprises inheritance information memory means for storing inheritance information; and inheritance information output means for outputting inheritance information stored in the inheritance information memory means to the outside. The information transmission system comprises mating means for combining inheritance information output by the inheritance information output means of a plurality of robots to produce new inheritance information of the other self-supporting type inheritance information memory means for voluntarily deciding action.

In such an information transmission system, the robot outputs inheritance information stored in the inheritance information memory means to the outside by inheritance information output means, and the mating means combines inheritance information output by the inheritance information output means of a plurality of robots to produce new inheritance information stored in the other self-supporting type inheritance information memory means for voluntarily deciding action. Thereby, the robots take action affected by the succeeded inheritance information.

In the information transmission method according to the present invention for achieving the aforementioned object, inheritance information output from a plurality of self-controlling type robots for voluntarily deciding action are combined to produce new inheritance information, and new inheritance information succeeded by another self-controlling type robots for voluntarily deciding action.

According to the information transmission method as described above, the robots take action affected by the succeeded inheritance information.

Further, the robot according to the present invention for achieving the aforementioned object comprises mating means for combining a plurality of pieces of inheritance information of a plurality of another robots to produce new inheritance information; inheritance information memory means for storing the inheritance information produced by the mating means; and inheritance information output means for outputting the inheritance information stored in the inheritance information memory means.

In the robot constituted as described above, a plurality of pieces of inheritance information of a plurality of other robots are combined by the mating means to produce new inheritance information, and inheritance information stored in the inheritance information memory means for storing the inheritance information are output by the inheritance information output means. Thereby, the robots take action affected by the succeeded inheritance information.

The information transmission method according to the present invention for achieving the aforementioned object comprises: mating step for combining inheritance information of a plurality of robots to produce new inheritance information; memory step for storing the inheritance information produced by the mating step in inheritance information memory means; and inheritance information output step for outputting the inheritance information stored in the inheritance information memory means.

By such an information transmission method as described above, the robots take action affected by succeeded inheritance information.

The information recording medium according to the present invention for achieving the aforementioned object stores therein information for causing the robots to execute mating step for combining a plurality of pieces of inheritance information of a plurality of other robots to produce new inheritance information; memory step for storing the inheritance information produced by the mating step in inheritance information memory means; and inheritance information output step for outputting the inheritance information stored in the inheritance information memory means.

By such an information transmission method as described above, the robots take action affected by succeeded inheritance information.

Further, the on-line sales system according to the present invention for achieving the aforementioned object comprises: a first terminal for registering inheritance information of a self-controlling type robot for voluntarily deciding section on the on-line; a second terminal for purchasing inheritance information of the desired robot out of registered robots; and a sales server having inheritance information registered and for selling inheritance information of the registered robots.

### THE BRIEF DESCRIPTION OF THE DRAWINGS

FIG. 1 is a block diagram showing a part for succeeding inheritance information of a robot device in a mating system according to an embodiment.

FIG. 2 is a perspective view showing an external appearance of the robot device described above.

FIG. 3 is a block diagram showing the mating system described above.

FIG. 4 is a block diagram showing the mating system described above developed on the Internet.

FIG. 5 is a flowchart showing the procedure for changing inheritance information through the growth or learning of the robot device.

FIG. 6 is a view used for explaining a case where “a blood type” is succeeded as inheritance information.

FIG. 7 is a view used for explaining a case where a parameter of “activity” is succeeded as inheritance information.

FIG. 8 is a block diagram showing a concrete example of the robot device described above.

FIG. 9 is a block diagram showing the constitution of a controller of the robot device described above.

FIG. 10 is a block diagram showing the constitution of a feeling-instinct model of the controller described above.

FIG. 11 is a view used for explaining a finite automaton employed as an algorithm of the action model described above.

FIG. 12 is a view used for explanation of the transition of a state in a posture transition mechanism section of the controller described above.

FIG. 13 is a block diagram showing the robot device according to the embodiment, which is a robot device provided with a mating section.

FIG. 14 is a view used for explaining a concrete example in a case of mating with inheritance information of a robot device owned by a well-known person or the like on the network.

FIG. 15 is a block diagram showing the constitution of an on-line sales system in which inheritance information of a robot owned by a well-known person or the like is purchased or mated on the network.

FIG. 16 is a flowchart showing the procedure for registering ID information in a sales server of the on-line sales system described above.

FIG. 17 is a flowchart showing the procedure for registering inheritance information of the robots in the sales server described above.

FIG. 18 is a view used for explaining one example of a purchasing page representative of information of the robots registered.

FIG. 19 is a flowchart showing the procedure for mating with inheritance information of the robots represented on the purchasing page described above.

### BEST MODE FOR CARRYING OUT THE INVENTION

The embodiments of the present invention will be describe in detail hereinafter with reference to the drawings. In the embodiments, the present invention is applied to mating system in which new inheritance information obtained by mating between a plurality of robot devices is succeeded to other robot devices.

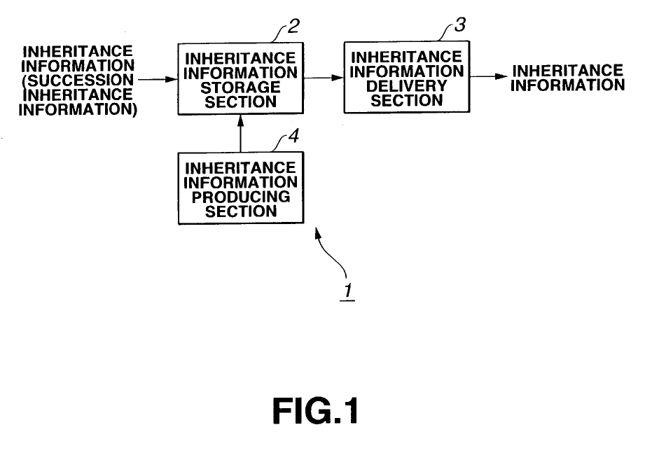

In the mating system, a robot device for succeeding inheritance information comprises, as shown in FIG. 1, a inheritance information memory section 2 having inheritance information of the robot device 1 stored therein; inheritance information delivery section 3 which is inheritance information output means for outputting inheritance information stored in the inheritance information memory section 2 to the outside; and inheritance information producing section 4 which is inheritance information renewal means for renewing inheritance information stored in the inheritance information memory section 2.

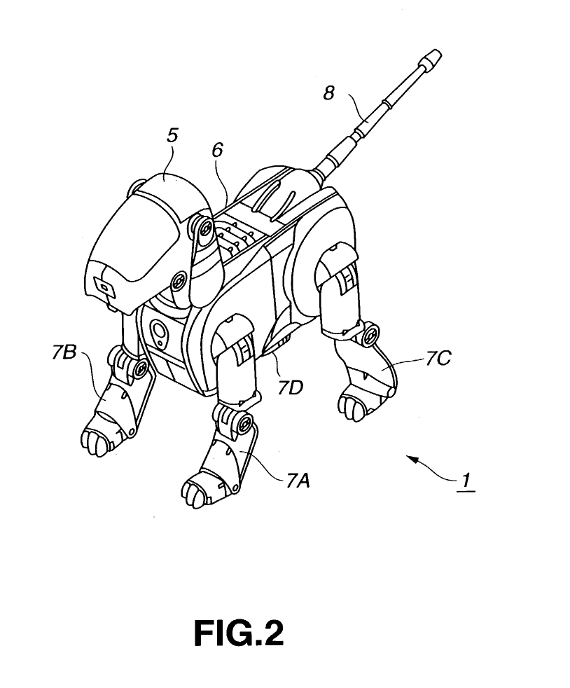

For example, an external shape of the robot device 1 is a shape in imitation of a dog, as shown in FIG. 2. The robot device 1 is constituted by connecting a head part 5 corresponding to the head, a body part 6 corresponding to the body, feet parts 7A, 7B, 7C, and 7D corresponding to the feet, and a tail part 8 corresponding to the tail, whereby the head part 5, the feet parts 7A to 7D, and the tail part 8 are moved relative to the body part 6 so that the robot device may be operated as in a genuine four-footed animal. For example, on the head part 5 are mounted an image recognition part corresponding to an eye and comprising, for example, a CCD (Charge Coupled Device) camera for photographing an image, a mike corresponding to an ear and collecting voices, and a speaker corresponding to a mouth and emitting a voice. Although being described in detail later, the robot device 1 is constituted as a self-controlling type robot device for voluntarily deciding action due to an external factor or an internal factor.

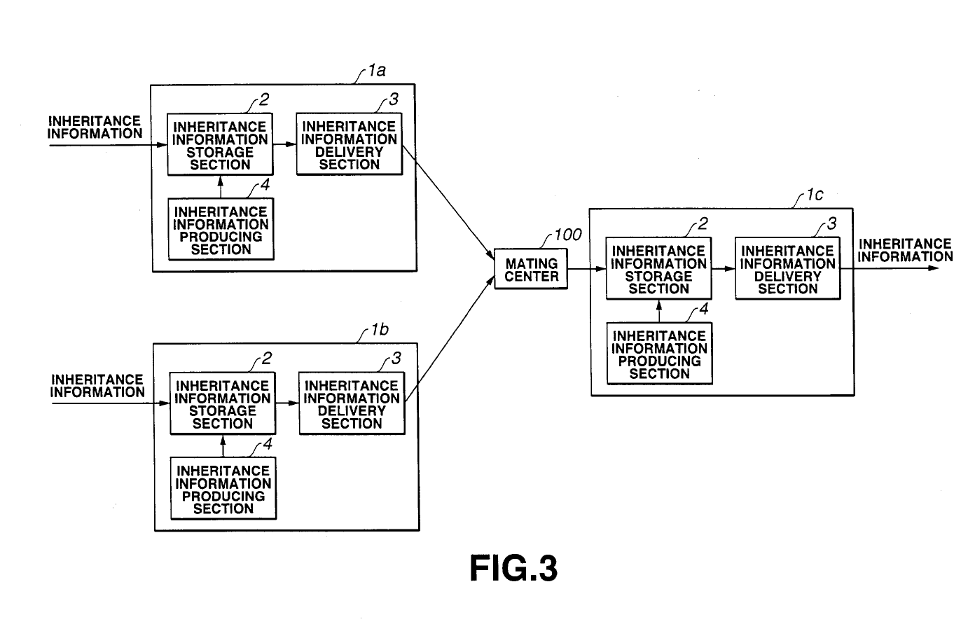

The mating system is constructed as shown in FIG. 3, and carries out succession of inheritance information by such a robot device 1 as described above. The mating system comprises, as shown in FIG. 3, robot devices (hereinafter referred to as parent robot devices) 1a, 1b for outputting inheritance information, a mating center 100 for producing new inheritance information by combining inheritance information from the parent robot devices 1a, 1b, namely, producing new inheritance information by so-called “mating”, and a robot device (hereinafter referred to as a child robot device) 1c which succeeds new inheritance information obtained by “mating” of the mating center 100.

The parent robot devices 1a, 1b are basically similar in constitution to that of the child robot device 1c, and they are provided with the inheritance information memory section 2, the inheritance information delivery section 3, and the inheritance information producing section 4. The robot device may serve as the “parent robot device” or the “child robot device” depending on the using mode (the side for succeeding inheritance information or the side by which inheritance information is succeeded). In the following, the processing within the mating system including the inheritance information memory section 2, the inheritance information delivery section 3, and the inheritance information producing section 4 will be described in detail.

The inheritance information memory section 2 is memory means in which inheritance information is stored temporarily. Here, inheritance information is at least a piece of information out of information for deciding constitution, information for deciding from, and information for deciding action of the robot 1. That is, for example, inheritance information include information relating to character of the robot device 1.

Further, inheritance information stored in the inheritance information storage section 2 may be inheritance information being succeeded or may be inheritance information newly obtained by renewal. That is, inheritance information may be inherent or may be posterior. Concretely, inheritance information newly obtained by renewal is information obtained as a result of self-supporting action such as information acquired by learning function, information acquired in the growth stage, or information of character.

Further, inheritance information also includes universal information, for example, such as “blood type” and “eye color”, that are not influenced by self-supporting action.

New inheritance information is produced (renewed) by inheritance information producing section 4 which is inheritance information renewal means for renewing inheritance information by self-supporting action, in the following manner.

Although described later concretely, the robot device 1 carries out deciding voluntary action by changing a parameter according to an external factor or an internal factor, and according to the parameter. For example, the parameter includes a parameter of “character” which changes according to an external factor or an internal factor. Therefore, in cases where a parameter for deciding action changes according to “character”, the robot device decides action by which character is expressed according to an external factor or an internal factor, and operates.

The inheritance information producing section 4 extracts such a parameter as described as inheritance information, and inheritance information stored in the inheritance information storage section 2 is renewed by the extracted inheritance information. That is, own independent inheritance information obtained during the course of growth or learning and inheritance information having been succeeded from “parent” are combined to renew inheritance information. Thereby, the inheritance information succeeded from “parent” is information different from inheritance information succeeding to next generation (outputting to “child”).

In the parent robot devices 1a and 1b, the inheritance information stored in the inheritance information delivery section 3 is delivered to a mating centre 100. For example, the delivery of inheritance information from the parent robot devices 1a and 1b is carried out by radio communication or wire communication. For example, the wired or wireless data communication may include those done by a so-called Internet.

In the mating centre 100, inheritance information having been sent from the two parent robot devices 1a and 1b as described above produce new inheritance information by so-called “mating” work. For example, the “mating” work is that inheritance information obtained from the parent robot devices 1a and 1b by the law prescribed in advance are combined to produce new inheritance information.

For example, the “mating” work may be done by methods known in the natural world, for example, such as Mendel's laws or inheritance laws of DNA. New inheritance information produced in the mating centre 100 is then delivered to the child robot device 1c using the data communication such as the Internet as described above.

In the child robot device 1c, the inheritance information having been sent from the mating centre 100 is temporarily stored in the inheritance information storage section 2. And, the child robot device 1c is affected by the inheritance information as described above to decide action voluntarily. Further, the child robot device 1c is constituted as a self-controlling type robot device such as to decide action voluntarily, similar to the aforementioned parent robot devices 1a and 1b, and renews inheritance information by independent information obtained by the voluntary action, similar to the case described above.

The inheritance information of the child robot device 1c is delivered, at the predetermined time, for example, at the “mating time”, to the mating centre 100, where the “mating” work is done again.

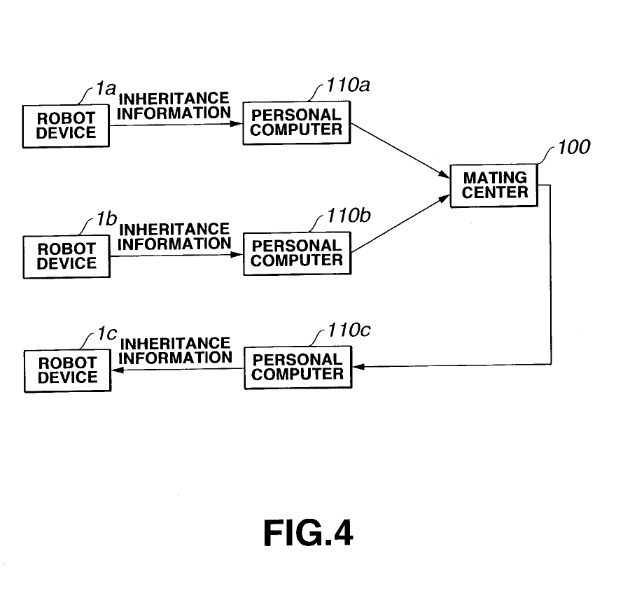

Now, how the mating system is developed on the so-called Internet will be concretely explained with reference to FIG. 4.

As shown in FIG. 4, first, the inheritance information obtained in the parent robot devices 1a an 1b are taken into personal computers 110a an 110b, respectively, connected on the network.

Taking of inheritance information from the parent robot devices 1a and 1b into the personal computers 110a and 110b is carried out wirelessly or wiredly, or through the information recording medium. The information recording medium is a so-called memory stick. For example, the robot devices 1a and 1b are provided with data communication means for carrying out data communication by wirelessly or wiredly between external equipment, whereby inheritance information is transmitted to the personal computers 110a and 110b by wirelessly or wiredly. Further, the robot devices 1a and 1b are provided with a memory stick slot making the memory stick detachable, whereby inheritance information is transmitted to the personal computers 110a and 110b through the memory stick.

Inheritance information taken into the personal computers 110a and 110b are delivered to the mating centre 100 through the wired or wireless network. In the mating centre 100, new inheritance information is produced from the inheritance information having been sent by the “mating” work, as described above. For example, in cases where such a “mating” work in the mating centre 100 is provided as the service, accounting is carried out with respect to the “mating” work.

The mating centre 100 delivers inheritance information newly obtained to the personal computer 110c having the child robot device 1c connected thereto through the wired or wireless network. The child robot device 1c receives inheritance information through the personal computer 110c. For example, receiving of inheritance information is carried out by wireless or wire communication or through the information recording medium such as a memory stick, and concretely, carried out by being provided with data communication means or a memory stick slot, similar to the parent robot devices 1a and 1b.

In cases where the mating system is developed on the Internet, processing is done as described above.

While in the aforementioned embodiment, delivery and reception of inheritance information from the robot devices 1a , 1b, and 1c are carried out by the personal computers 110a, 110b, and 110c, it is to be noted that such delivery and reception may be also carried out a single personal computer. For example, this is a case where one and the same user carries out mating of the robot device.

The mating system on the on-line using the Internet as described above will be described in detail later.

Inheritance information of the robot device can be succeeded to other robot devices by the mating system constructed by the robot devices 1a, 1b, and 1c and the mating centre 100 as described above.

An effect is exerted upon inheritance information having been succeeded by a parameter which is changed by an external factor or an internal factor used to decide action voluntarily in the robot device, whereby inheritance information being succeeded changes according to the environments. Thereby, the robot device (“parent robot device”) is able to cause skill or character acquired newly through the growth or learning to succeed to other robot devices (“child robot device”). Further, inheritance information are succeeded one after another to thereby form a group or mass of robot devices having flexibility that can be applied to a variety of environments.

In the above-described embodiment, a description has been made of the case where the succession of the inheritance information is carried out in a relationship of a general succession system of inheritance between the “parent” robot device and the “child” robot device. However, such a succession as described above is not limited thereto, that is, the succession of the inheritance information need not always grasped as succession of inheritance information corresponding to the “mating” of male and female animals. For example, it is also possible to obtain new inheritance information from three or more robot devices.

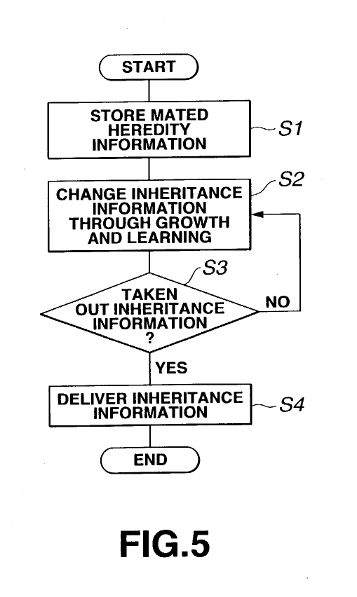

Further, for example, the decision of action based on the inheritance information in the robot devices and the renewal of inheritance information can be carried out in the following procedure as shown in FIG. 5.

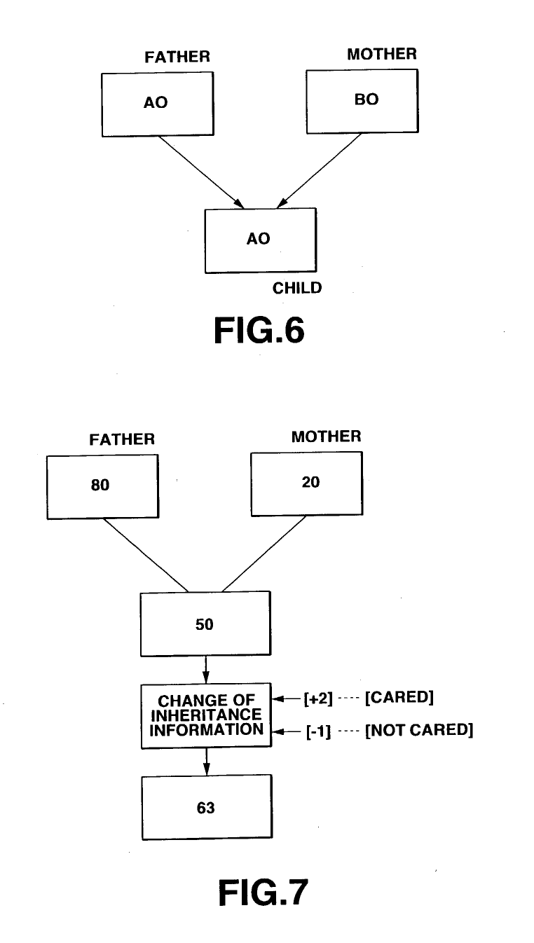

In Step S1, mated (succeeded) inheritance information is stored in the inheritance information storage section 2. The mated inheritance information is, concretely, information in which in cases where the “father”'s blood type is “AO”, and the “mother”s blood type is “BO”, the “child”s blood type is “AO”, as in a human being, as shown in FIG. 6. Further, in cases where a parameter of the “father”s “activity (volition)” is “80”, and a parameter of mother's “activity” is “20”, as shown in FIG. 7, the mated inheritance information is information in which a parameter of the “child”'s activity is “50”.

The robot device 1 is affected by the parameter of “activity” and the “blood type” as described above to decides action. Hereupon, in the decision of action affected by the “blood type”, for example, the action having character different depending upon the blood type expressed similar to the human being is taken.

Further, where “A” and “B” are superior factors, and “O” is a recessive factor, similar to the human being, it is also possible to allow the integral robot device to have a “blood type” comprising a combination of such factors as described above. In this case, the father's robot device is a A-type having factors “A” and “B”, and the mother's robot device is a B-type having factors “B” and “O”, as shown in FIG. 6. It is supposed that by mating of the parent together, the child robot device inherits a factor of “A” and a factor of“O” from the father's robot device and the mother's robot device, respectively. As a result, the robot device of the born child has factors “A” and “O”, but since the factor “A” is superior to that of “O”, an actualized blood type of the child's robot device is a “A” type. As just mentioned above, it is also possible to allow the robot device to have a “blood type” as a combination of the superior and recessive factors, similar to the human being.

In the succeeding step S2, an effect is exerted on the inheritance information stored in the inheritance information storage section 2 through the growth or learning to change it.

Hereupon, for example, the inheritance information of the “blood type” as described above is universal within the robot device, and is not affected through the growth and learning. On the other hand, the parameter of “activity” is affected through the growth and learning so that it is changed through the growth and learning. For example, when cared much by a human being, “2” is added to a parameter of “activity”, and when left alone for a given period, “1” is subtracted from a parameter of “activity”. For example, in the robot device, the judgement of “cared” is carried out by contact detection of a touch centre provided in the head part. For example, when the touch centre is depressed, judgment is made to be cared, and “2” is added to a parameter of “activity”; and when the touch sensor is not depressed for a given period, judgment is made not to be cared, and “1” is subtracted from a parameter of “activity”.

And, in Step 3, discrimination is made whether or not the changed inheritance information is taken out. That is, for example, discrimination is made, for example, whether the time is “mating time”. In this Step 3, processing for changing inheritance information in the aforementioned Step S2 is done till judgment is made in the aforementioned Step S2 that inheritance information is taken out. In a case where judgment is made that inheritance information is taken out, the procedure proceeds to Step S4, where processing of taking out inheritance information is done. For example, a “AO” blood type is delivered as inheritance information, and “63” is delivered as a parameter of the changed “activity”.

As described above, the robot device in which inheritance information is succeeded is constituted as a self-supporting robot device for voluntarily deciding action. The concrete constitution of the self-controlling type robot 1 will be explained hereinafter.

(1) Constitution of a Robot Device

As shown in FIG. 2, the robot device 1 has its external appearance constituted, and is constituted by connecting a head part 5 corresponding to the head, a body part 6 corresponding to the body, feet parts 7A to 7D corresponding to the feet, and a tail part 8 corresponding to the tail, whereby the head part 5, the feet parts 7A to 7D, and the tail part 8 are moved relative to the body part 6 so that the robot device may be operated as in a genuine four-footed animal.

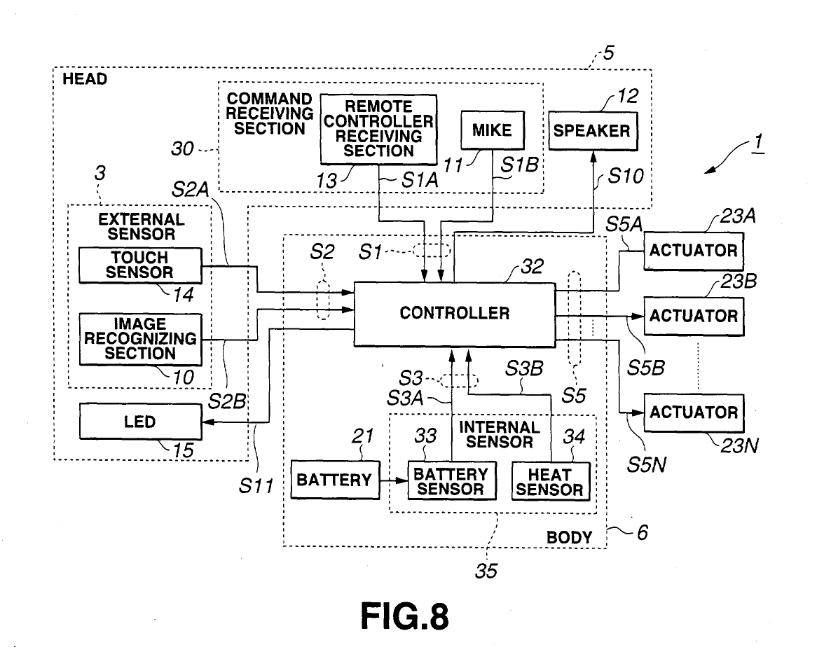

In the robot device 1, as shown in FIG. 8, on the head part 5 are, at a predetermined position, mounted an image recognition part 10 corresponding to an eye and comprising, for example, a CCD (Charge Coupled Device) camera for photographing an image, a mike 11 corresponding to an ear and collecting voices, a speaker 12 corresponding to a mouth and emitting a voice, and LED 15 corresponding to eye expression and proving external output by a plurality forms of emissions. For example, by controlling emission of LED 15, the eye expression and color can be changed. For example, succession of “eye color” by inheritance information is done by making LED 15 a predetermined color.

Further, on the head part 5 are mounted a remote controller receiving part 13 for receiving instructions transmitted through a remote controller (not shown) from a user, and a touch sensor 14 for detecting that the user's hand is placed in contact.

On the body part 6 is mounted a battery 21 at a position corresponding to the body, internally of which an electronic circuit (not shown) for controlling the operation of the whole robot device 1 is housed.

Articulate portions of the feet parts 7A to 7D, connection portions between the feet parts 7A to 7D, connections portions between the body part 6 and the head part 5, and connection portions between the boy part 6 and the tail part 6 are respectively connected by actuators 23A to 23N, and are driven on the basis of the control of the electronic circuit housed in the body part 6. As described above, in the robot device 1, the actuators 23A to 23N are driven whereby the head part 5 is shaken in all directions, the tail part 8 is shaken, and the feet parts 7A to 7D are moved to effect walking or running, thus achieving operation as in a genuine four-footed animal.

(2) Circuit Constitution of a Robot Device

Circuit constitution of the robot device 1 is constituted, for example, as shown in FIG. 8. A head 5 has a command receiving section 30 comprising a mike 11 and a remote controller receiving section 13; an external sensor 31 comprising an image recognizing section 10 and a touch sensor 14; a speaker 12; an LED 15. Further, a body 6 has a battery 21; a controller 32 for controlling operation of the whole robot device 1; and an internal sensor 35 comprising a battery sensor 33 for detecting the remainder of the battery 21 and a heat sensor 34 for detecting heat generated within the robot device 1. Further, the robot device 1 is provided at a predetermined position with actuators 23A to 23N.

The command receiving section 30 is provided to receive instructions, for example, instructions such as “walk”, “lid down”, and “chase a ball”, and is constituted by the remote controller receiving section 13 and the mike 11. When desired instructions are input by operation of the user, a remote controller (not shown) transmits infrared rays corresponding to the instructions input to the remote controller receiving section 13. The remote controller receiving section 13 receives the infrared rays to produce a received signal SIA, and transmits it to the controller 32. When the user makes a voice corresponding to the desired instructions, the mike 11 collects voices made by the user to produce a voice signal SIB, and delivers it to the controller 32. In the manner as described above, the command receiving section 30 produces, in response to the instructions given from the user to the robot device 1, an instructions signal S! Comprising the received signal SIA and the voice signal SIB, and supplies it to the controller 32.

The touch sensor 14 of the external sensor 31 is provided to detect action of a user upon the robot device 1, for example, action such as “stroke” and “pat”. When the user touches the touch sensor 14 to make the desired action upon, the touch sensor 14 produces a contact defection signal S2A corresponding to the action, and delivers it to the controller 32.

The image recognizing section 10 of the external sensor 31 is provided to detect, as a result of recognition of the surrounding environment of the robot device 1, surrounding environmental information, for example, such as “dark” and “There is a favorite toy.” or action of other robot devices, for example, such as “The other robot device is running.”, and photographs an image around the robot device 1, and delivers an image signal S2B obtained as a result therefrom to the controller 32. In the manner as described above, the external sensor 31 produces an external information signal S2 comprising the contact detection signal S2A and the image signal S2B in response to the external information given from the outside of the robot device 1 to deliver it to the controller 32.

The internal sensor 35 is provided to detect internal states of the robot device 1 itself, for example, internal states such as “feel hungry” which means that the battery capacity lowers and “feverish”, and is constituted by a battery sensor 33 and a heat sensor 34.

The battery sensor 33 is provided to detect the remainder of the battery 21 for supplying powder to circuits of the robot device 1, and delivers a battery capacity detection signal S3A which is a result detected to the controller 32. The heat sensor 34 is provided to detect heat within the robot device 1, and delivers a heat detection signal S3B as a result therefrom to the controller 32. In the manner as described above, the internal sensor 35 produces an internal information signal S3 comprising the battery capacity detection signal S3A and the heat detection signal S3B in response to internal information of the robot device 1 to deliver it to the controller 32.

The controller 32 produces, on the basis of an instructions signal S1 supplied from the command receiving section 30, an external information signal S2 supplied from the external sensor 31, and an internal information signal S3 supplied form the internal sensor 35, control signals S5A to S5N for driving actuators 23A to 23N, and delivers these signals to the actuators 23A to 23N to drive the latter whereby the robot device 1 is operated.

At that time, the controller 32 produces a voice signal S10 to be output to the outside and an emission signal S11 as occasion demands to output the voice signal S10 to the outside through the speaker 12 or deliver the emission signal S11 to the LED 15 to provide emission output as the desired form so as to inform the user of necessary information such as “be angry” and “sorrow”.

(3) Data Processing in a Controller

The controller 32 applies softwise data processing, on the basis of a program prestored in a predetermined memory area, to the instructions signal S1 supplied from the command receiving section 30, the external information signal S2 supplied from the external sensor 31, and the internal information signal S supplied from the internal sensor 35, and supplies a control signal S5 obtained by the result therefrom.

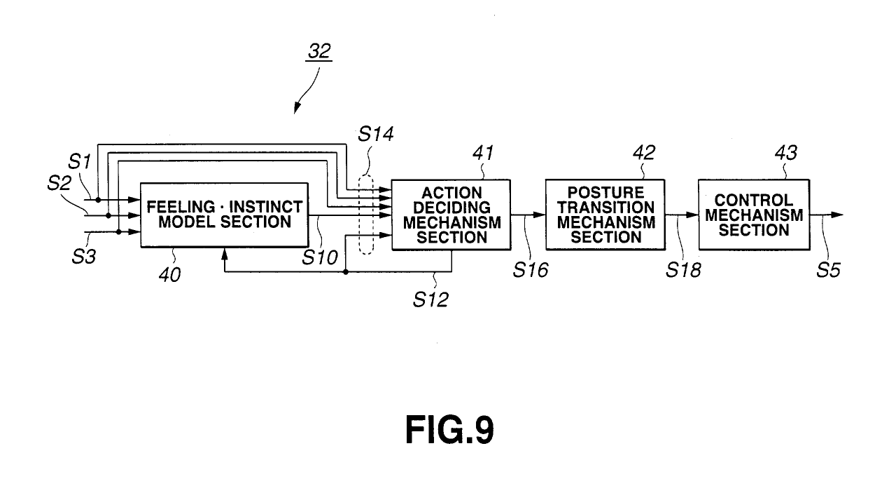

As shown in FIG. 9, the controller 32, comprises, according to functional classification of contents of the data processing, a feeling-instinct model section 40 as feeling and instinct model changing means, an action deciding mechanism section 41 as operation state deciding means, posture transition mechanism section 42 as posture transition means, and a control mechanism section 43. Tile controller 32 has the feeling-instinct model section 40 to thereby function as action and/or operation producing means for changing the model on the basis of input information to produce action and/or operation. Further, the controller 30 is provided with a function for controlling operation on the basis of information of a growth model according to a growth degree.

The controller 32 inputs the instructions signal S1 supplied from the outside, the external information signal S2, and the internal information signal S3 into the feeling-instinct model section 40, and the action deciding mechanism section 41.

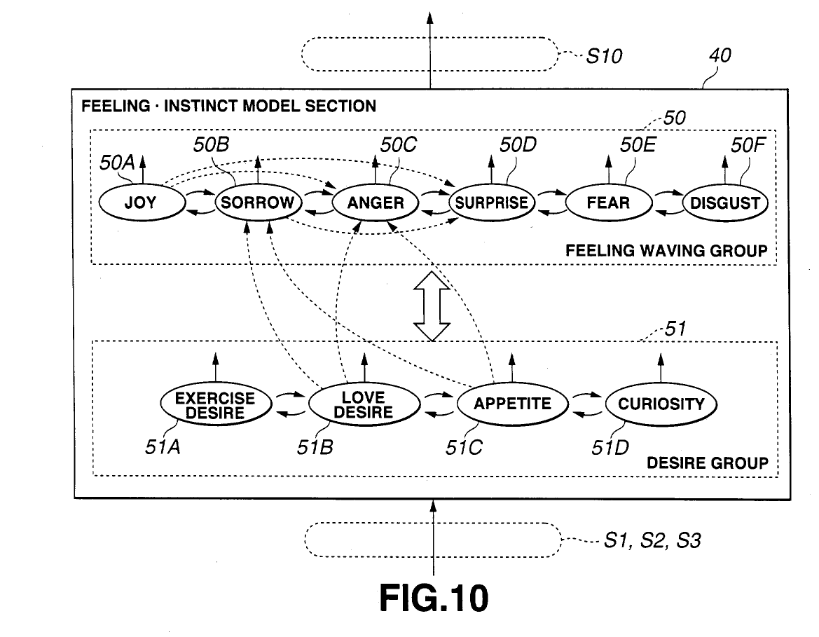

As shown in FIG. 10, the feeling-instinct model section 40 has a feeling wave section 50 comprising feeling wave parts 50A to 50F as a plurality of independent models, and a desire group 51 comprising desire parts 51A to 51D as a plurality of independent desire models.

The feeling wave group 50 includes the feeling wave part 50A of “joy”, the feeling wave part 50B of “sorrow”, the feeling wave part 50C of “anger”, the feeling wave part 50D of “surprise”, the feeling wave part 50E of “fear”, and the feeling wave part 50F of “disgust”.

The desire group 51 includes the desire part 51A of “desire for exercise”, the desire part 51B of “desire for love”, the desire part 51C of “appetite”, and the desire part 51D of “curiosity”.

The feeling wave parts 50A to 50F express the degree of feeling wave by strength, for example, to 0 to 100 level, and momentarily change the strength of feeling wave on the basis of the instructions signal S1, and the external information signal S2, and the internal information signal S3 respectively supplied. The feeling wave parts 50A to 50F also influence on each other so that the strength is changed. The feeling-instinct model section 40 combines the strengths of the momentarily changing feeling wave parts 50A to 50D to thereby express the state of the feeling of the robot device 1 to make the time change of feeling model.

The desire parts 51A to 51D express, similarly to the feeling wave parts 50A to 50F, the degree of desire by strength, for example, to 0 to 100 level, and momentarily change the strength of desire on the basis of the instructions singnal S1, and the external information signal S2, and the internal information signal S3 respectively supplied. The desire parts 51A to 51D also influence on each other so that the strength is changed. Thus, the feeling-instinct model group 40 combines the strengths of the momentarily changing desire parts 51A to 51D to thereby express the state of the instinct of the robt device 1 to make the time change of instinct model.

Further, the feeling group 50 and the desire group 51 influence on each other so as to change the strength. For example, when “desire for love” is fulfilled, feeling of “anger” and feeling of “sorrow” are suppressed; and when “appetite” is not fulfilled, feeling of “anger” and feeling of “sorrow” get excited. In the manner as described above, the state affected complicatedly by the mutual action of feeling and desire can be expressed.

The feeling-instinct model section 40 as described above change the strengths of the feeling wave parts 50A to 50F and the desire parts 51A to 51D on the basis of input information S1 to S3 comprising the instructions signal S1, and the external information signal S2, and the internal information signal S3, respectively. The feeling-instinct model section 40 combines the strengths of the changed feeling wave parts 50A to 50F to thereby decide the state of feeling, and combines the strengths of the changed desire parts 51A to 51D to thereby decide the state of feeling and instinct to deliver the decided state of feeling and instinct to the action deciding mechanism section 41 as feeling-instinct information S10.

Returning to FIG. 9, the action deciding mechanism section 41 decides the following action on the basis of input information S14 comprising the instructions signal S1, and the external information signal S2, the internal information signal S3, the feeling-instinct information S10, and action information S12, and delivers contents of the decided action to the posture transition mechanism section 42 as action instructions information S16.

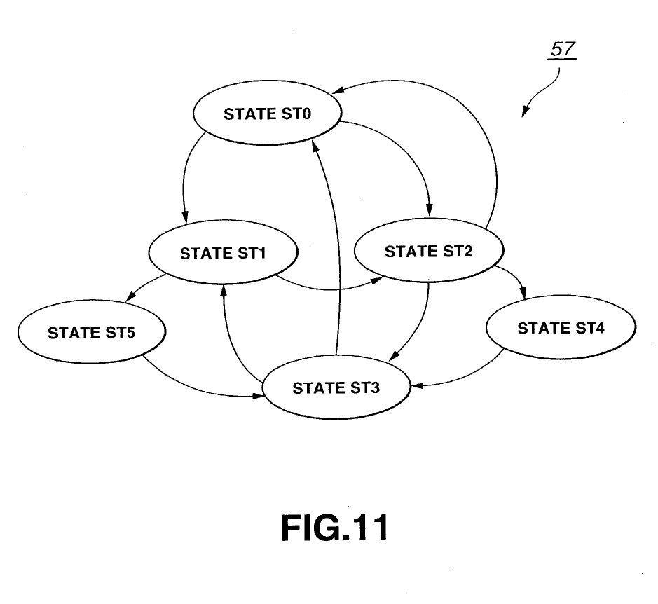

Concretely, as shown in FIG. 11, the action deciding mechanism section 41 uses an algorithm called a finite automaton 57 in which history of input information S14 supplied in the past is expressed by an operating state (hereinafter called a state), and having a finite number of states for transiting the state to a separate state on the basis of the input information S14 supplied at present, and the state at that time so as to decide next action. The algorithm for deciding the action in the action deciding mechanism section 41 will be hereinafter referred to as an action model. The action deciding mechanism section 41 transits the state every time the input information S14 is supplied, and decides the action according to the transited state whereby the action is decided referring to not only the present input information S14 but also the past input information S14.

Accordingly, for example, in State ST1 of “chasing a ball”, when the input information of “ball is not seen” is supplied, the state is transited to State ST5 of “standing up”; whereas in State ST2 of “sleeping”, when the input information of “get up” is supplied, the state is transited to State ST4 of “standing up”. It is understood in these State ST4 and State ST5 that even if the action is the same, the history of the past input information S14 is different, and the state is also different.

Actually, the action deciding mechanism section 41 transits, when detects that a predetermined trigger is present, the present state to next state. Concrete examples of the trigger include, for example, that the time for executing the action of the present state reaches a given value, that specific input information S14 is input, or that the strength of a part (feeling wave part or desire part) out of the strengths of the feeling wave parts 50A to 50F and the desire parts 51A to 51D expressed by the feeling-instinct sate information S10 supplied from the feeling-instinct model section 40 exceeds a predetermined threshold.

At that time, the action deciding mechanism section 41 selects the state at destination of transition on the basis whether or not the desired feeling wave part or desire part out of the strengths of the feeling wave parts 50A to 50F and the desire parts 51A to 51D expressed by the feeling-instinct state information S10 supplied from the feeling-instinct model section 40 exceeds a predetermined threshold. Thereby, the action deciding mechanism section 41 transits to the different state according to the strength of the feeling wave parts 50A to 50F and the desire parts 51A to 51D, even if the same instructions signal S1 is input.

Accordingly, the action deciding mechanism section 41 produces, when detects that the palm is lain before eyes based on the external information signal S2 supplied, detects that the strength of the “angry” feeling wave part 50C is less than a given threshold based on the feeling-instinct state information S10, and detects that “not feel hungry”, namely, a battery voltage is not less than a predetermined threshold based on the internal information signal S3, an action instructions information S16 for causing the operation of “hand!” to effect according to the fact that the palm is lain before eyes to deliver it to the posture transition mechanism section 42.

For example, the action deciding mechanism section 41 produces, for example, when detects that the palm is lain before eyes, the strength of the “angry” feeling wave part 50C is less than a given threshold, and “feel hungry”, namely, a battery voltage is less than a predetermined threshold, produces action instructions information S16 for causing operation of “licking the palm” to effect to deliver it to the posture transition mechanism section 42.

Further, the action deciding mechanism section 41 produces, for example, when detects that the palm is lain before eyes, and the strength of the “angry” feeling wave part 50C is not less than a given threshold, action inspections information S16 for causing operation of “look aside in a huff” to effect irrespective of whether or not “not feel hungry”, namely, a battery voltage is not less than a predetermiened hreshold to deliver it to the posture transition mechanism section 42.

Furthermore, the action deciding mechanism section 41 decides parameters of action taken in the state at transition destination, for example, such as walking speed, the magnitude or speed when hand and foot are moved, level or magnitude of sound when makes sound and so on, on the basis of the desired feeling wave part or desire part out of the strengths of the feeling wave parts 50A to 50F and the desire parts 51A to 51D expressed by the feeling-instinct state information S10 supplied from the feeling-instinct model section 40 to produce action instructions information S16 according to the parameter of the action to deliver it to the posture transition mechanism section 42.

Further, the learning function of the robot device 1 of the robot device 1 is realized, for example, by the action deciding mechanism section 41. That is, for example, action instructions information S16 based on information obtained in the past is produced by the action deciding mechanism section 41.

Concretely, in the action deciding mechanism section 41, the infinite automaton 57 shown in FIG. 11 noted as an algorithm of the action model stores the past transition channel according to the input information S14 to realize “learning function”. For example, in cases where transition operation “skill” of “kick a ball” as a result of “found a ball” is not stored as a general action model, such a transition channel is stored to realize the learning function by acquiring new transition operation.

Needless to say, the learning function is not limited to such a transition operation as described. For example, the skill that balance is held in a floor of a slippery flooring can be obtained by the learning function. Further, while in the present embodiment, a description has been made of the case where the learning function is realized by the action deciding mechanism section 41, it is to be noted that the embodiment is not limited thereto. It can be also realized by other blocks.

Further, the action instructions information S16 decided by the action deciding mechanism section 41 is fedback to the feeling-instinct model section 40. Thereby, the feeling-instinct model section 40 is affected by the action instructions information S16 fedback to change the strength of the feeling wave parts 50A to 50F ro the desire parts 51A to 51D. For example, if he action instructions information S16 shows action accompanied by “walk”, “desire for exercise” is to be fulfilled to change the strength of the desire part 51A of “desire for exercise”.

Further, the action instruction information S16 decided by the action deciding mechanism section 41 is again fedback to the action deciding mechanism section 41. Thereby, when the action deciding mechanism section 41 comprises the feeling-instinct state information S10 from the feeling-instinct model section 40, the action-decided information S16 is incorporated into the input information 14 to enable deciding the action instructions information S16.

As described above, the action deciding mechanism section 41 decides the following action on the basis of the input information S14 comprising an instructions signal S1, an external information signal S2, an internal information signal S3, feeling-instinct state information S10, and action information 12. And, the action deciding mechanism section 41 decides action according to a growth model.

The growth model in the controller is a model such that the robot device 1 changes action and operation as if the genuine animal “grows”.

Concretely, the robot device 1 performs action and operation according to four “growth stages”, i.e., “infancy”, “boyhood”, “full age”, and “adult” by the growth model. For example, in a memory not shown of the controller 32 are prestored information of the growth model which comprises the basis of action and operation relating to four items, i.e., “walking state”, “motion (movement”, “action”, and “sound (cry)” every “growth stage”.

And, in the growth model, transition is made as in “infancy”, “boyhood”, “full age”, and “adult” according to “growth stage”, and the robot device 1 performs the action and operation corresponding thereto.

The growth model is provided, concretely, with the action model as mentioned above every growth stage of “infancy”, “boyhood”, “full age”, and “adult”, and an action model according to each growth stage is selected to thereby perform action according to the growth. For example, the difference according to “growth stage” of the action model is expressed by difficulty and complexity of action and operation. The details are as follows:

The controller 32 controls the actuators 23A to 23N and the voice outputs, in accordance with the action model of “infancy” at the initial time, for example, so that with respect to “waling state”, a stride is made small to be “toddling”; with respect to “motion”, to be “simple” movement to a degree of merely “walk”, “stands up”, and “sleep”; with respect to “action”, to be “monotonous” by repeating the same action; and with respect to “sound”, to be “small and short” cry by lowering the amplification rate of a voice signal S6.

Further, at this time, the controller 32 always monitors and counts occurrence of a plurality of elements (hereinafter referred to as growth elements) concerned in predetermined “growth” such as instructions inputs using a sound commander (a remote controller), strengthened learning comprising sensor inputs through a touch sensor 14 corresponding to “stroke” and “pat” and times of successes of action and operation determined, sensor inputs through a touch sensor 14 not corresponding to “stroke” and “pat”, and predetermined action and operation such as “play with a ball”.

The accumulated number of the growth elements serves as information indicative of the growth degree. The controller 32 changes, when a total value of the accumulated number of the growth elements (hereinafter referred to as a synthetic experienced value of growth elements) exceeds a preset threshold, a using action model to an action model of “boyhood” which is higher in growth level (a level such as difficulty or complexity of action or operation) than the action model of “infancy”.

And, the controller 32 controls the actuators 23A to 23N and voice outputs from the speaker 12 in accordance with the action model of the “boyhood” in future, for example, so that with respect to “walking state”, the rotational speed of the actuators 23A to 23N is increased so as to walk “somehow firmly”; with respect to “motion”, the number of movements is increased to be “somehow high (degree) and complicated” movement; with respect to “action”, reference is made to the previous action to decide next action to be action having “somewhat object”; and with respect to “sound”, the length of the voice signal S6 is extended and the amplification rate is increased to be “somewhat long and big” cry.

Similarly thereto, afterward, the controller 32 sequentially changes, every time the synthetic experienced value of the growth elements exceeds each threshold prest corresponding to “full-age” or “adult”, respectively, the action model to action models of “full-age” or “adult” which is herein “growth stage” to gradually increase the rotational speed of the actuators 23A to 23N or the length or amplification rate of the voice signal S10 given to the speaker 21 or change the speed of the actuators 23A to 23N when one operation takes place.

The action and the operation are decided by the growth model as described above, whereby the robot device 1 stepwisely changes, as the “growth stage” rises (that is, changes from “infancy” to “boyhood”, from “boyhood” to “full-age”, and from “full-age” to “adult”), that in “walking state”, from “toddling walk” to “steady walk”; in_“motion”, from “simple” to “high (degree)-complicated”; in “action”, from “monotonous” to “action with object”; and in “sound”, from “small and short” to “long and big”.

Returning to FIG. 9, the posture transition mechanism section 42 produces posture transition information S18 for transiting a posture from the present posture to the next posture on the basis of the action instructions information S16 supplied from the action deciding mechanism section 41 to deliver it to the control mechanism section 43. In this case, a posture from the present posture to the next posture is decided, for example, by a shape and weight of the body, a hand and a foot, a physical shape of the robot device 1 like a connected state of parts, and a mechanism of the actuators 23A to 23N, for example, such as a direction or angle at which a joint is bent.

For example, the posture that can be transited is classified into a posture that can be transited directly from the present posture, an a posture that cannot be transited directly. For example, the four-footed robot device 1 can be transited directly from a state being lain down with hand and foot widely spread out to a state of being lain, but cannot be transited directly to a stand-up state, and two stages of operation, i.e., a posture of once drawing hand and foot near the body and lain down, and then a posture that stands up are necessary. Further, there is a posture that cannot be executed safely. For example, the four-footed robot device 1 is sometimes fallen down simply when attempted to raise both front feet in a standing posture to make cheers (‘banzai’).

Accordingly, in cases where a posture that can be transited is preregistered, an the action instructions information S16 supplied from the action deciding mechanism section 41 shows the posture that can be transited directly, the posture transition mechanism section 42 delivers the action instructions information S16 to the control mechanism section 43 without modification as the posture transition information S1, whereas in cases where it shows a posture that cannot be transited directly, the posture transition mechanism section 42 produces posture transition information S1 such that the posture is once transited to the other posture that can be transited, after which transiting to the intended posture to deliver it to the control mechanism section 43. Thereby, the robot device 1 is able to avoid a situation that the posture that cannot be transited is forcibly executed, or a falling-down situation.

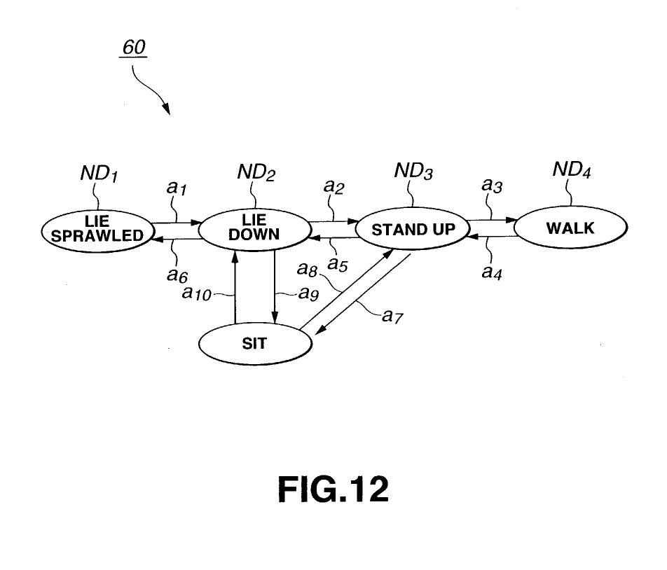

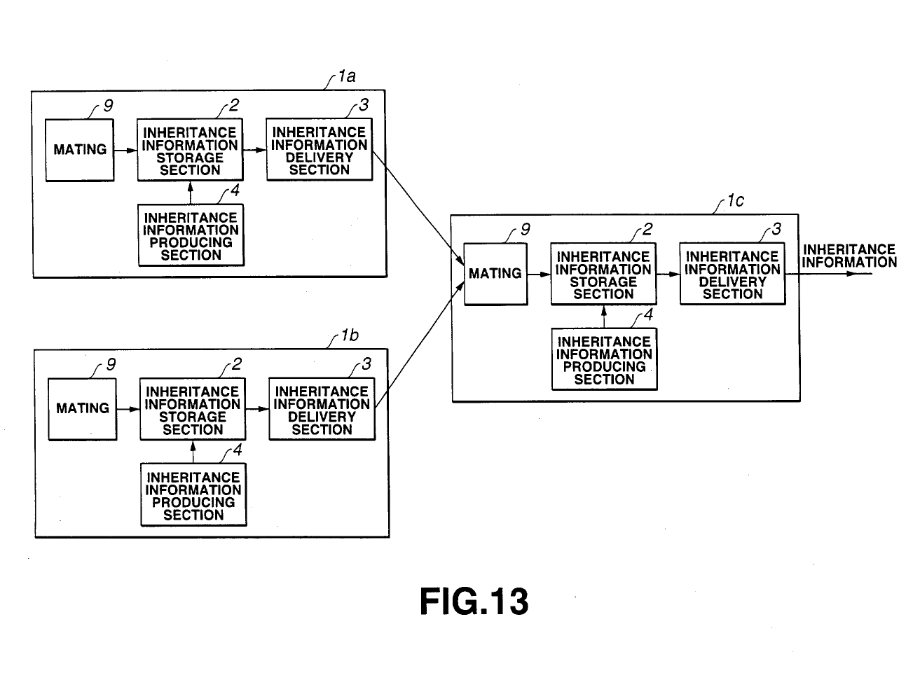

Concretely, the posture transition mechanism section 42 is designed so as to preregister postures that can be taken by the robot device 1, and to record a space between two postures that can be transited. For example, as shown in FIG. 12, the posture transition mechanism section 42 uses an algorithm called an oriented graph 60 in which the postures that can be taken by the robot device 1 are indicated by nodes ND₁ to ND₅, and the space between two postures that can be transited, that is, between the nodes ND₁ to ND₅ are connected by oriented arcs a₁ to a₁₀.

The posture transition mechanism section 42 searches for a channel from the present node ND to the next ND while following the direction of an oriented arc a so as to connect the node ND corresponding to the present posture with the node ND corresponding to a posture taken next indicated by the action instruction information S16, and the nodes ND on the searched channel are recorded in order to thereby perform a plan of posture transition. Thereby, the robot device 1 is able to realize the action instructed by the action deciding mechanism section 41 while avoiding a situation that the posture that cannot be transited is forcibly executed, or a falling-down situation.

The posture transition mechanism section 42 utilizes the fact that for example, in a case where the present posture is at the node ND₂ indicating the posture “lie down”, when the action instructions information S16 indicating “sit down!” is supplied, the node ND₂ indicating the posture “lie down” can be transited directly to the node ND₅ indicating the posture “sit down” to give the posture transition information S1 indicating “sit down!” to the control mechanism section 43. On the other hand, the posture transition mechanism section 42 searches for, when the action instructions information S16 indicting “walk!” is supplied, a channel from the node ND₂ indicating “lie down” to the node ND₄ indicating “walk” to thereby perform a posture transition plan, as a result of which action instructions information S1 which issues instructions indicating “walk!” after instructions indicating “stand up!” has been issued is produced to deliver it to the control mechanism section 43.

Returning to FIG. 9, the control mechanism section 43 produces a control signal S5 for driving the actuator 23 on the basis of the action instructions information S1 to deliver it to the actuator 23 to drive the actuator 23 whereby the robot device 1 causes to perform the desired operation.

(4) Operation and Effect

In the foregoing constitution, the feeling-instinct model section 40 of the controller 32 changes the feeling and instinct states of the robot device 1 on the basis of input information S1 to S3 supplied, and the change of the feeling and instinct states is reflected on the action of the robot device 1 to cause the robot to voluntarily act on the basis of its own feeling and instinct.

Further, the growth model of the controller 32 changes a degree of growth of the robot device 1, and the change of the degree of growth is reflected on the action of the robot device 1 to cause it voluntarily act on the basis of its own degree of growth.

Thereby, the robot device 1 is possible to voluntarily act on the basis of its own feeding and instinct or a degree of growth, thus enabling taking action close to a genuine pet.

And, the robot device 1 extracts, in a case where inheritance information is succeeded to the other robot device, information relating to inheritance, as inheritance information, from information (skill) or the like acquired by the strength and the learning function of the feeling wave parts 50A to 50F and the desire parts 51A to 51D of the feeling-instinct model section 40 obtained in the process of growth, and renews the inheritance information.

Further, in the other robot device 1 having succeeded new inheritance information obtained as a result of “mating” work of inheritance information in the mating centre 100, a decision is made of action affected by the succeeded inheritance information, for example, such as the strength or the skill of the feeling wave parts 50A to 50F and the desire parts 51A to 51D of the feeling-instinct model section 40.

(5) Other Embodiments

In the following, other embodiments in addition to the aforementioned embodiments will be described in detail.

(5-1) Robot Having a Mating Part

While in the aforementioned embodiments, a description has been made of the case where the mating section is developed in the network such as an Internet, and the constitution of the robot device 1 may also be applied thereto, it is noted that the present embodiment is not limited thereto. For example, as shown in FIG. 9, the robot device 1 itself can be provided with a mating section 9.

In this case, for example, parent robot devices 1a and 1b, and a child robot deice 1c are connected by wired or wireless data communication or using an information recording medium, and in the child robot device 1c, “mating” work is carried out. For example, in the case where the “mating” work is carried out using the information recording medium, two data recording media in which inheritance information of the parent robot devices 1a and 1b are recorded are replaced by the mating section 9 of the child robot device 1c to thereby carry out the “mating” work. It is noted that the “mating” work is not limited to carrying it by the mating section 9 of the child robot device 1c, but for example, it may be also carried out by inserting into the mating section of one robot device an information recording medium in which inheritance information of the other parent robot device 1c.

Further, in the mating system, for example, inheritance information of a given robot can be also accumulated in a mating centre 100. For example, a gene of a robot bred by others such as a celebrity is accumulated (registered). Thereby, also, new inheritance information is obtained by “mating” work with the robot bred by a celebrity to succeed it to the robot. Further, a gene of a robot bred by a celebrity is purchased to succeed it to the robot.

(5-2) Concrete Examples of a Mating System Using an Internet

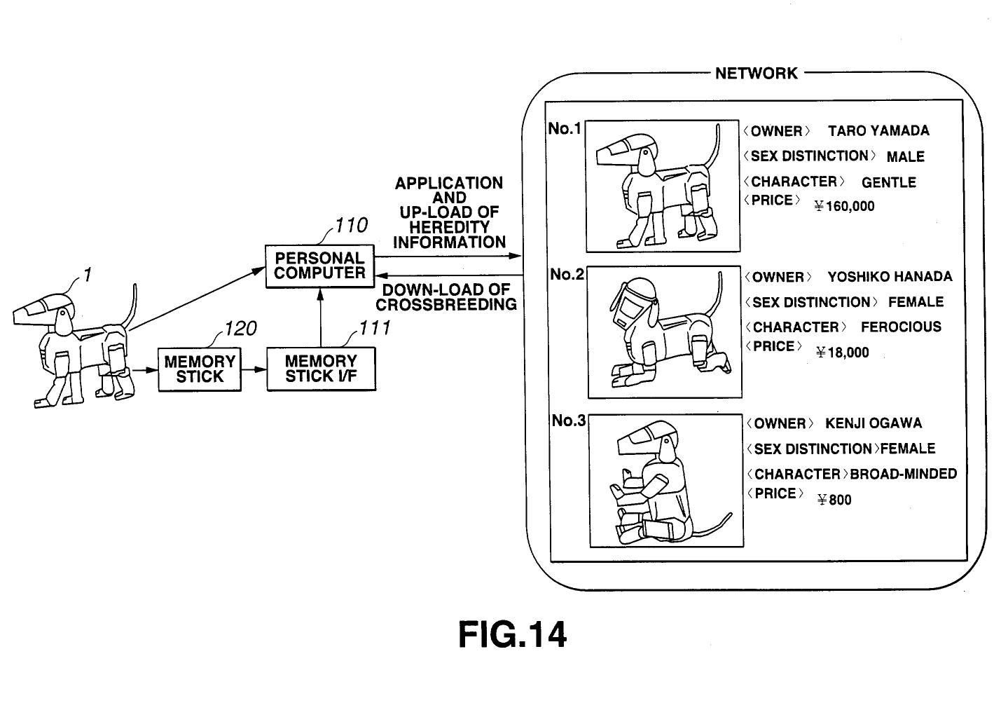

In the following, concrete examples of a mating system using an Internet will be described. For example, as shown in FIG. 14, general users, celebrities and the like register, on the network, own (owner) name, or inherent information such as photograph, sex distinction or character of own robot device, or sales price (or mating price).

And, the user who desires to mate with the robot device registered on the network as described applies for mating, and performs up-load on the network of inheritance information of own robot device 1. The up-load of inheritance information on the network is carried out, for example, in the following procedure.

For example, the user records inheritance information of the robot device 1 on a memory stick 120 which is an information recording medium, and incorporates inheritance information into a personal computer 110 through a memory stick interface 111 by the memory stick 120. Or, inheritance information of the robot device 1 is incorporated into the personal computer 10 by wireless or wire communication. Then, inheritance information is up-loaded on the network from the personal computer.

The up-loaded inheritance information is “mated” with inheritance information of the robot device of the desired celebrity selected by the user, which is down-loaded as new inheritance information to the user.

In the following, a further concrete example including a presenter of inheritance information will be described. As a concrete example, a description will be made of an on-line sales system in which a gene of a robot bred by the other person is purchased as mentioned above, or new inheritance information is obtained by “mating” work with a gene of a robot bred by the other person to enable it succeeding to the robot.

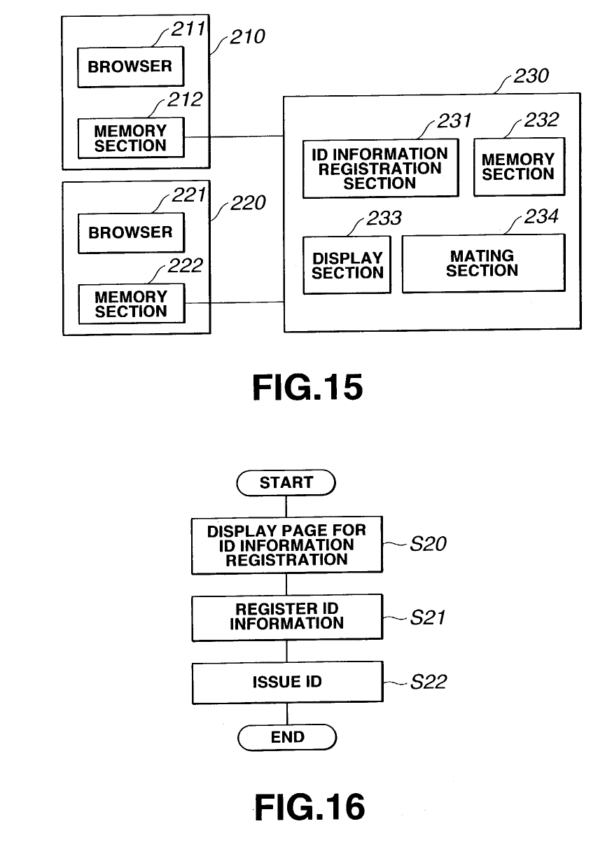

As shown in FIG. 15, an on-line sales system 200 comprises a present side terminal 210 as a first terminal for registering inheritance information of a robot bred by owner on a sales server 230 described later, a purchase side terminal 210 as a second terminal for purchasing inheritance information of the registered robot, and a sales server 230 for registering and selling inheritance information of the robot. The present side terminal 210 and the purchase side terminal 220, are, for example, a personal computer. Networks between the present side terminal 210 and the sales server 230, and between the purchase side terminal 220 and the sales server 230 are, for example, an Internet. Hereupon, the purchase also includes the purchase of new inheritance information having inheritance information of a robot transmitted from the purchase side terminal 220 and inheritance information of a robot registered in the sales server 230 combined. It is noted that the sales server 230 may be grasped as the aforementioned mating centre 100.

The present side terminal 210 comprises a browser 211 for displaying and reading a web page, and a memory section 212 for storing inheritance information and the like. The purchase side terminal 220 comprises a browser 221 for displaying and reading a web page, and a memory section 222 for storing inheritance information and the like.

The sales server 230 comprises an ID information registration part 231 for setting ID information to the present side terminal 210 and the purchase side terminal 220 to register it, a memory part 232 for storing inheritance information of a robot presented from the present side terminal 210, a display part 233 for displaying information of the registered robot on a web page, and a mating part 234 for “mating” inheritance information of the registered robot and inheritance information of a robot transmitted from the purchase side terminal 220.

The basic operation of the on-line sales system 200 is as follows. When inheritance information of a robot is presented through the present side terminal 210, the sales server 230 resisters the inheritance information to store it in the memory part 232. The sales server 230 displays the desired information out of the registered information on the display part 233. Contents displayed will be described in detail later. The user purchases inheritance information of the desired robot out of robots displayed on the display part 232.

Hereupon, the ID information registration will be explained. For example, the user of the present side terminal 210 and the user of the purchase side terminal 220 manage (control) the utilization of the on-line sales system 200 by the ID information. ID information registration is carried out in the procedure as shown in FIG. 16. First, in Step S20, a page for ID information registration is displayed on a browser.

Then, in Step S21, ID information is registered. Information registered at this time may be information necessary for specifying a user such as an individual name or the like. In Step S21, a password may be also registered. The information registered here is stored in the ID information registration section.

Finally, in Step S22, ID is issued to complete the procedure. In a case where in Step S21, a password is registered, the password is also issued simultaneously.

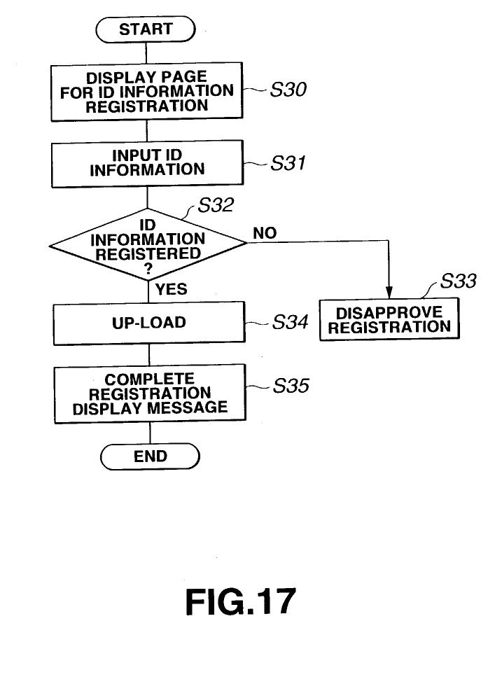

Next, the procedure carried out when inheritance information of a robot is registered will be explained with reference to FIG. 17. In a case where ID information registration has been already done, registration processing takes place here. First, in Step S30, a page for registration is displayed on a browser 211.

Then, in Step S31, ID information is input. In a case where a password is issued, a password is also input.

Next, discrimination is made whether or not the ID information input in Step S32 is one registered in the ID information registration section 231. In a case where the ID information is not one registered in the ID information registration section 231, the procedure proceeds to Step S33, where registration is disapproved. In this case, it may be jumped to the page for ID information registration. In a case where the input ID information is one registered in the ID information registration section 231, the procedure proceeds to Step S34.

In Step S34, up-loading of information of a robot takes place. Hereupon, at least information on robots desired to be registered, for example, such as photograph, sex distinction, character, or inherent information such as growth stage, sales price of inheritance information (or a mating price) and the like are up-loaded. Further, a name of a breeder (owner) or the like is sometimes up-loaded.

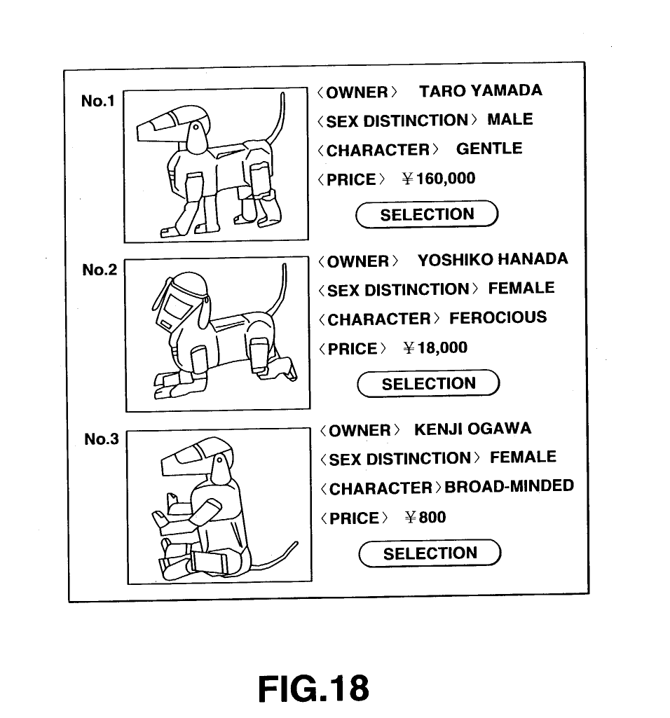

In the manner as described, information of the up-loaded robot are stored in the memory section 232, and the desired information out of them is displayed on the display section 233. A page for purchase on which the information of a robot is displayed is, for example, as shown in FIG. 18. While in FIG. 18, a name of an owner, a photograph, sex distinction and a character of robots, and a sales (or mating) price are merely displayed, it is to be noted that those to be displayed are not limited thereto, items set by the sales server 230 such as the growth stage described above are displayed in addition thereto.

It is to be noted that the photograph of a robot may be an animation image. By employment of an animation image, action and operation according to the growth stage would become clear for a person who desires to purchase (or mate).

Further, in Step S34, inheritance information of a robot is up-loaded. Up-loading of inheritance information is concretely carried out in the following. Inheritance information of a robot is recorded in a memory stick which is an information recording medium, and inheritance information is incorporated into a memory section 212 of a present side terminal 210 through a memory stick interface by the memory stick. Or, for example, inheritance information of a robot is incorporated into a memory section 212 of a present side terminal 210 by wireless or wire communication. Then, inheritance information is up-loaded on the network from the present side terminal 210.

When the inheritance information of a robot is stored in a memory section 232, a registered message is sent from a sales server 230 to a resent side terminal 210 and displayed on a browser 211, in Step S35, to complete the registration procedure.

It is noted that in Step S34, inheritance information of a robot may be up-loaded after receipt of the purchase (or mating) desire. In this case, a notice to the effect that the purchase (or mating) was received is given to user of the present side terminal 210. This notice is done by a so-called e-mail.

Further, inheritance information or the like of a robot may be done by a page for ID information registration. That is, the page for ID information registration may be common to the page for registration.

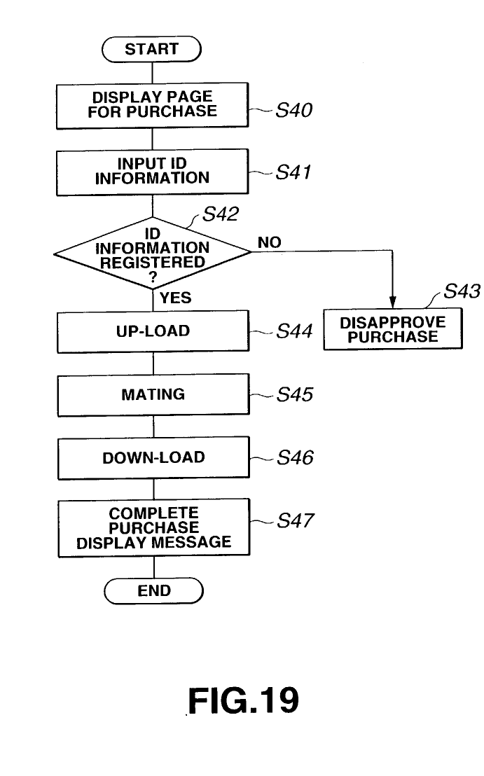

Next, the procedure carried out when inheritance information of a robot is purchased (or bred) will be explained. The procedure for carrying out mating is explained in FIG. 19. In a case where the IS information registration has already been done, mating processing carries out here. First, in Step S40, a page for purchase is displayed on a browser. A user of a terminal for purchase 220 selects a robot which desires mating out of robots of a page for purchase. A plurality of robots may be selected. In this case, mating is carried out between a plurality of robots.

Then, in Step S41, ID information is input. In a case where a password is issued, a password is also input.

Next, discrimination is made whether or not the ID information input in Step S42 is one registered in an ID information registration section 231. If not, the procedure proceeds to Step S43, where the purchase is disapproved. In this case, jumping to the page for ID information registration may be done. In a case where the input ID information is one registered in the ID information registration section 231, the procedure proceeds to Step S44.

In Step S44, up-loading of inheritance information of a robot is carried out. The up-loading is carried out in the procedure described above. That is, inheritance information of a robot is recorded in a memory stick which is an information recording medium, and inheritance information is incorporated into a memory section 222 of a purchase side terminal 220 through a memory stick interface by the memory stick. Or inheritance information is incorporated into a memory section 222 of a purchase side terminal 220, for example, by wireless or wire communication. And, inheritance information is up-loaded on the network from the purchase side terminal 220. The up-loaded inheritance information is sent to a mating section 234.

Then, in Step S45, “mating” is carried out. In “mating” hereupon, inheritance information of a robot selected in the page for purchase and inheritance information up-loaded from the purchase side terminal 220 are combined by a rule provided in advance to produce new inheritance information. Also in a case where the robots selected in the page for purchase are plural in number, “mating” is likewise carried out. New inheritance information may be produced on the basis of the parameter of “activity” or inheritance information of “blood type” as described above.

New inheritance information produced in the mating section 234 is down-loaded to the terminal for purchase 220 in Step S40. The down-loaded inheritance information is recorded in a memory stick through a memory stick interface not shown. Or after being stored in the memory section 222, inheritance information is sent into a robot, for example, by wireless or wire communication.

Then, in Step S47, a purchased message is sent from a sales server 230 to a purchase side terminal 220 and displayed on a browser 221 to complete mating processing.

In a case where “mating” is not carried out in the sales server 230 but only inheritance information of a robot selected in the page for purchase is purchased, the aforementioned Step S44 an Step S45 are omitted. That is, discrimination is made whether or not ID information input in Step S42 is one registered in the ID information registration section 231. If not, processing proceeds to Step S43, where registration is disapproved. In a case where the input ID information is one registered in the ID information registration section 231, processing proceeds to Step S46.

In Step S46, the purchased inheritance information is down-loaded to the terminal for purchase 220. The down-loaded inheritance information is recorded in an unrecorded memory stick through a memory stick interface not shown. Or, after being stored in the memory section 222, inheritance information is sent into a robot, for example, by wireless or wire communication.

Then, in Step S47, the purchased message is sent from the sales server 230 to the purchase side tenmiual 220 and displayed on the browser 221 to complete purchase processing.

In this case, the purchased inheritance information is sent to the mating section within a robot, and in the mating section, “mating” is carried out.

It is noted that mating is not necessarily carried out, but the purchased inheritance information can be succeeded without modification. In this case, the robot may have a selecting function to enable selection whether or not “mating” takes place.

Next, payment of a charge will be explained. The user of the purchase side terminal 220 pays, as a result of the purchase (or mating) as described above, a purchase charge (or a mating charge). For example, the user of the purchase side terminal 220 pays a charge directly to an owner of a robot who has done purchasing (or mating) of inheritance information. Or, the user of the purchase side terminal 220 may pay a charge directly to the sales server 230, and the sales server 230 may pay an amount of money from which a fee (commission) is subtracted to an owner of a robot. In this case, it is necessary at least for the user of the purchase side terminal 220 to register a number of a credit card when ID information is registered.

While in the aforementioned explanation, registration of ID information need be done in advance, the matter is not limited thereto, but individual information such as a name or the like may be input every time registration or purchase of inheritance information is done.

Further, the sales server 230 may extract the desired information with respect to the robot device from inheritance information of the up-loaded robot to display it on the page for purchase. In this case, the user of the present side terminal 210 need not to input information with respect to the robot at the time of registration, and only up-loading of inheritance information of a robot and a photograph (or animation image) will suffice.

Those sold in the sales server 230 may be not only inheritance information of a robot, but also a memory stick on which inheritance information of a robot is recorded, and a robot having the inheritance information.

While in the aforementioned explanation, the present side terminal 210 and the purchase side terminal 220 are different from each other, for convenience's sake, it is of course possible to make registration and purchase with the same terminal.

Further, the user of the present side terminal 210 may be the traders specialized in selling inheritance information of a robot, and the user of the purchase side terminal 220 may be the general users.

Also, in the manner as described above, new inheritance information can be obtained by the purchase (or mating) of inheritance information of a robot bred by a celebrity or the like to succeed it to the robot.

(5-3) Others

Decision of action based on inheritance information in the robot device 1 or renewal of inheritance information mentioned above can be executed on the software. Also, by renewing a program of an application program, it is possible to provide a renewal function of inheritance information in the robot device 1. For example, the application program of the robot device 1 can be renewed by the presentation of an information recording medium on which such as control step is recorded, and more concretely, inheritance information of a plurality of other robot devices are combined, and control step for causing the robot device to execute mating step for producing new inheritance information, memory step for storing the inheritance information produced by the mating step in inheritance information memory means, and inheritance information output step for outputting the inheritance information stored in the inheritance information memory means enables renewing of an application program of the robot device 1 by the presentation of an information recording medium in which information is recorded.

Further, in the foregoing embodiments, description has been made of the case where the feeling wave group 50 is constituted by the feeling wave sections 50A to 50F showing “joy”, “sorrow”, “anger”, “surprise”, “fear”, and “disgust”, and the desire group 51 is constituted by the desire sections 51A to 51D showing “desire for exercise”, “desire for love”, “appetite”, and “curiosity” whereby the states of feeling and instinct are decided by these feeling wave sections 50A to 50F and the desire sections 51A to 51D, but the matter is not limited thereto. That is, for example, a feeling wave part showing feeding wave of “loneliness” can be also added to the feeling wave group 5.

Further, in the foregoing embodiments, description has been made of the case where an algorithm called a finite automaton 57 was used to decide next action. However, the matter is not limited thereto, but an algorithm called a state machine in which a number of states is not finite may be used to decide action, in which case, a new state is produced every time input information S14 is supplied, and action may be decided according to the produced state.

Furthermore, in the foregoing embodiments, description has been made of the case where an algorithm called a finite automaton 57 was used to decide next action. However, the matter is not limited thereto, but alternatively, action may be decided using an algorithm called a probability finite automaton in which a plurality of states are selected as candidates at destination of transition on the basis of the input information S14 supplied at present and the states at that time, and a state at destination of transition out of the plurality of states selected is decided at random by random number.

Further, in the foregoing embodiments, description was made of the case where the items which change with the “growth” consist of four items, i.e., “walking state”, “motion”, “action”, and “sound”. However, the matter is not limited thereto, but items other than those mentioned above may be changed with the “growth”.

Furthermore, in the foregoing embodiments, description was made of the case where the present invention is applied to the robot device 1. However, the present invention is not limited thereto, but the present invention can be applied to other various fields as in a robot used in an entertainment field, for example, such as a game or exhibition. For example, the present invention can be also applied, for example, to a case where a robot for voluntarily deciding action is expressed as animation.

The Industrial Applicability

By using the present invention as described above, the skill or character acquired by the self-supporting robot in the process of growth or learning, that is, inheritance information can be succeeded to other robots. Further, inheritance information is sold in on-line to enable succeeding the desired inheritance information, thus further enhancing the entertainment of robots.

1. An information transmission system comprising;
a plurality of self-controlling type robots which voluntarily decide actions thereof, each having inheritance information memory means for storing inheritance information of the robot, and inheritance information output means for outputting the inheritance information stored in the inheritance information memory means to outside; and
mating means for combining a plurality of pieces of inheritance information output from the inheritance information output means of the robots to produce new inheritance information to be stored in inheritance information memory means of another self-controlling type robot.

2. The information transmission system according to claim 1, wherein the inheritance information has at least a piece of information among information for deciding constitution, information for deciding form, and information for deciding actions of the robot.

3. The information transmission system according to claim 1, wherein each of the robots has inheritance information renewal means for renewing the inheritance information stored in the inheritance information memory means by self-controlling actions.

4. The information transmission system according to claim 3, wherein each of the robots has parameter change means for changing parameters according to external factors or internal factors, and action decision means for deciding actions according to the parameters; and
the inheritance information renewal means extracts the parameters as inheritance information to renew the inheritance information by the use of the extracted inheritance information.

5. The information transmission system according to claim 1, wherein each of the robots transmits the inheritance information stored in the inheritance information output means to the mating means by radio communication or wire communication; and
the mating means produces the new inheritance information by the use of a plurality of pieces of inheritance information transmitted from the robots.

6. The information transmission system according to claim 1, wherein each of the robots records the inheritance information stored in the inheritance information output means to a detachable information recording medium; and
the mating means produces the new inheritance information by the use of a plurality of pieces of inheritance information recorded in the information recording medium.

7. The information transmission system according to claim 1, wherein the mating means performs accounting according to the combination of the inheritance information.

8. An information transmission method comprising the steps of;
combining a plurality of pieces of inheritance information output from a plurality of self-controlling type robots which voluntarily decide actions thereof to produce new inheritance information; and
making another self-controlling type robot succeed to the new inheritance information.

9. A plurality of self-controlling type robots which voluntarily decide action thereof, each having mating means for combining a plurality of pieces of inheritance information of a plurality of another robots to produce new inheritance information;
inheritance information memory means for storing the inheritance information produced by said mating means; and
inheritance information output means for outputting the inheritance information stored in said inheritance information memory means.

10. The robot according to claim 9 wherein said inheritance information comprise at least a piece of information out of information for deciding constitution, information for deciding form, and information for deciding actions of said robot.

11. The robot according to claim 9 comprising inheritance information renewal means for renewing inheritance information stored in said inheritance information memory means by the self-controlling actions.

12. The robot according to claim 11 comprising parameter change means for changing parameters according to external factors and internal factors, and action decision means for deciding action according to said parameters; wherein
said inheritance information renewal means extracts said parameters as inheritance information to renew the inheritance information by use of the extracted inheritance information.

13. The robot according to claim 9 comprising receiving means for receiving inheritance information output by said another robots by radio communication or wire communication, wherein
said mating means produces said new inheritance information by a plurality of pieces of inheritance information received by said receiving means.

14. The robot according to claim 9 comprising a recording medium mounting part in which an information recording medium for storing inheritance information of said another robots is detachable; wherein
said mating means produces said new inheritance information by the use of a plurality of pieces of said inheritance information recorded in said information recording medium.

15. An information transmission method comprising;
mating step for combining a plurality of inheritance information output form a plurality of robots to produce new inheritance information;
memory step for storing the inheritance information produced by said mating step in inheritance information memory means; and
inheritance information output step for outputting the inheritance information stored in said inheritance information memory means.

16. An information recording medium storing therein information for causing a plurality of robots to execute the steps of;
combining inheritance information of a plurality of another robots to produce new inheritance information;
storing the inheritance information produced by said mating step in inheritance information memory means; and
outputting the inheritance information stored in said inheritance information memory means.

17. An on-line sales system for selling inheritance information of a self-controlling type robots which voluntarily decide actions, comprising;
a first terminal for registering inheritance information of said robot on the on-line;
a second terminal for purchasing inheritance information of the desired robot out of said registered robots; and
a sales server for having inheritance information of said robot registered and for selling the inheritance information of said registered robots.

18. The on-line sales system according to claim 17 wherein said sales server comprises mating means for combining a plurality of pieces of inheritance information of a plurality of said robots; and
said purchase is a purchase of new inheritance information obtained by transmitting inheritance information of said robot to said sales server through said second terminal and by combining said inheritance information and inheritance information of said desired robot by said mating means.

19. The on-line sales system according to claim 17 wherein said purchase is a purchase of an information recording medium in which said inheritance information is recorded through said second terminal.

20. The on-line sales system according to claim 17 wherein said purchase is a purchase of said robot having said inheritance information through said second terminal.

21. The on-line sales system according to claim 17 wherein said inheritance information comprises at least a piece of information out of information for deciding constitution, information for deciding from, and information for deciding action of said robot.

22. The on-line sales system according to claim 17 wherein said sales server comprises ID information registration means for setting inherent ID information to said first terminal an said second terminal.

23. The on-line sales system according to claim 17 wherein said sales server comprises memory means for storing inheritance information of said registered robot through said first terminal.

24. An on-line sales method comprising:
registration step for registering inheritance information of a self-controlling type robot for voluntarily deciding action sent through a first terminal in on-line; and
sales step for selling inheritance information of said robot registered by said registration step through a second terminal.

25. A sales server comprising:
registration means for registering inheritance information of a self-controlling type robot for voluntarily deciding action sent through a first terminal in on-line; and
sales means for selling inheritance information of said robot registered by said registration step through a second terminal.
